(19) United States
(12) Patent Application Publication
(10) Pub. No.: US 2014/0059840 A1
(43) Pub. Date: Mar. 6, 2014

(54) LOW RADAR CROSS SECTION ARRAY PANEL

(71) Applicants: Basil W. Thompson, JR., Hooksett, NH (US); Robert D. Smith, Chelmsford, MA (US); Almer M. Garnett, Hudson, NH (US)

(72) Inventors: Basil W. Thompson, JR., Hooksett, NH (US); Robert D. Smith, Chelmsford, MA (US); Almer M. Garnett, Hudson, NH (US)

(21) Appl. No.: 13/569,754

(22) Filed: Aug. 8, 2012

Related U.S. Application Data
(60) Provisional application No. 61/522,754, filed on Aug. 12, 2011.

(51) Int. Cl. H01Q 1/12

(52) U.S. Cl. CPC H01Q 1/12
USPC 29/600; 211/26

(57) ABSTRACT

A low RCS array panel employs a number of linkable support segments. Each support segment has several junctions spaced along it, and the support segments are designed to connect with each other at the junctions to create a support grid. The segments can connect orthogonally, and the junctions can be spaced according to the frequency performance requirements for the antenna the array panel is designed to support.

### RELATED APPLICATIONS

This Application claims rights under 35 USC §119 (e) from U.S. Provisional Application Ser. No. 61/522,754 filed Aug. 12, 2011, the contents of which are incorporate herein by reference.

### STATEMENT OF GOVERNMENT INTEREST

The invention was made with United States Government assistance under contract No. FA86290-06-G-4028-0008 awarded by the US Air Force. The United States Government has certain rights in the invention.

### FIELD OF THE INVENTION

The present invention relates to antenna support panels, and more particularly to low weight and low reflective antenna array support panels.

### BACKGROUND OF THE INVENTION

When supporting antenna elements in an array, element size and frequency range dictate the weight for the antenna array support. Typical array panels provide a ground plane that forms a large reflecting surface, causing undesirable radar reflection and a large Radar Cross Section (RCS). Planar array supports offer support for the element weight and create a ground plane with a large RCS, even for elements that may not require a ground plane. Particularly in the battlefield, a large RCS is a large detriment and can be extremely dangerous. A need therefore exists for an antenna array panel that provides consistent array geometry support while limiting weight and RCS.

### SUMMARY OF INVENTION

In order to solve the above problems, a low RCS array support panel includes a grid or lattice composed of a number of overlying support segments, with overlying support segments having junctions spaced along the support segments. In order to form the lattice, in one embodiment the overlying support segments are each designed to connect with each other at the junctions and may be secured by welding and the like. In one embodiment support plates are provided at the junction and are used to mount the antenna elements.

According to one embodiment, the support segments are designed to connect orthogonally at the junctions. In another embodiment, the support segments are made of minor image wire segments joined together along their lengths except at the junctions where they are opened to receive a support plate. In a further embodiment the support segments are made of non-metal members such as overlying plastic ribs. In another embodiment, the junctions are placed along the support segments according to the frequency requirements of the antenna array that will be supported by the array support panel.

More particularly, the low RCS array support panel in one embodiment, offers support for elements that do not require a ground plane, while reducing the RCS for the overall array, and at the same time providing a lower assembly weight. The low RCS array support panel permits the formation of antenna arrays of varying sizes with minimal reflecting surfaces. The low RCS array support panel in one embodiment provides support for antenna elements by using an easily assembled adjustable design. The array support panel also implements convenient pre-formed methods of construction so that antenna arrays may be fabricated and supported with a low RCS grid or lattice.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of an antenna array having elements patterned onto printed circuit cards, with the cards mounted in a diamond configuration utilizing slotted stanchions that are mounted to an antenna array support panel;

FIG. 2 is a diagrammatic illustration of a low radar cross section antenna array support panel useable for the antenna array of FIG. 1 showing non-interconnected overlying support segments made of side-by-side wire segments joined along the length thereof and having apertures adapted to surround and house support plates for mounting antenna elements;

FIG. 3 is a diagrammatic illustration of the low RCS array support panel of FIG. 2 showing the assembly thereof in which preformed side-by-side wire segments are welded in minor image pairs along the length thereof and have apertures that overlie corresponding apertures in an orthogonal underlying wire segment pair such that the support segments are connected at their junctions in a cross linked fashion that offers transverse support to the resulting grid or lattice;

FIG. 4 is a diagrammatic illustration of a slotted column or stanchion utilized to support printed circuit card antenna elements;

FIG. 5 is a diagrammatic illustration of the mounting of the columns or stanchions of FIG. 4 on the support plates supported at the junctions of the array support panel of FIG. 3; and,

FIG. 6 is a diagrammatic illustration of the support of four slotted columns or stanchions on array support panel plates, showing printed circuit card antenna elements located within associated slots to provide an interlocking structure.

### DETAILED DESCRIPTION

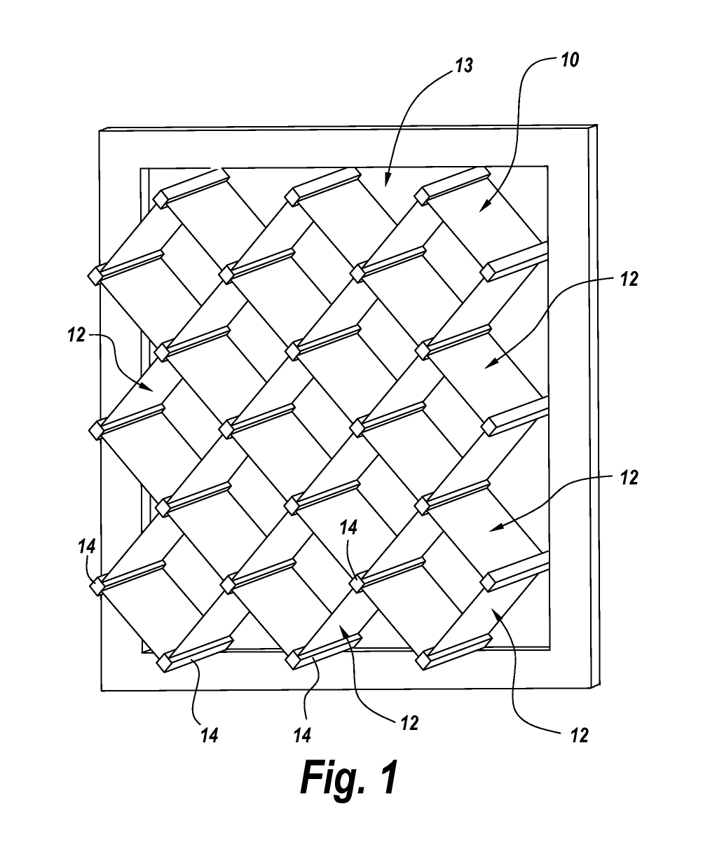

Referring now to FIG. 1, a planar antenna array 10 is composed a number of printed circuit card antenna elements 12 located in a diamond shaped pattern across an antenna array support panel 13, with antenna element printed circuit cards 12 being mounted between notched support columns 14 as illustrated.

One of the problems with the mounting of such an antenna array is to provide a support structure that has a relatively low radar cross section.

If, for instance the elements are mounted to a metalized support panel, for instance to provide a ground plane or the like for the antenna array, then the panel itself presents a relatively high radar cross section which is undesirable.

There is therefore a requirement to provide a suitable mounting system for antenna arrays, whether of the printed circuit card variety shown in FIG. 1 or individual elements extended up from a ground plane. It is the purpose of array support panel 13 to support the antenna array elements in the proper position along the array while at the same time minimizing the radar cross section.

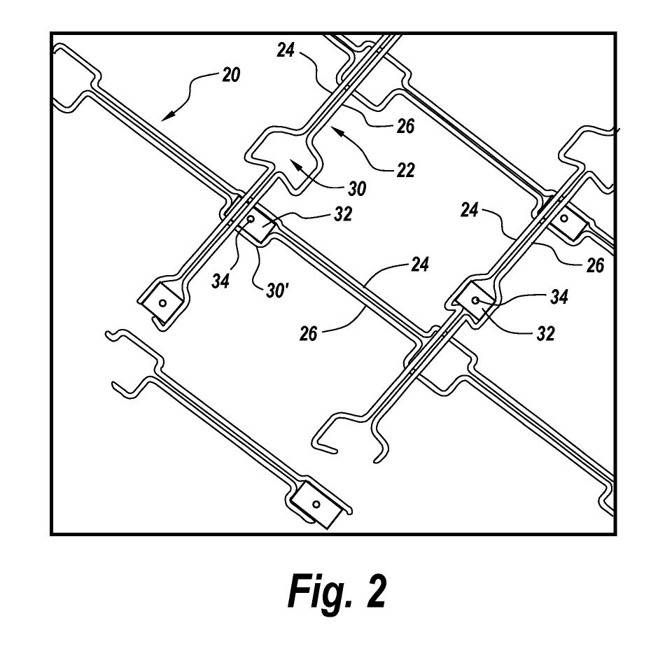

Referring to FIG. 2, a low radar cross section antenna array support panel in one embodiment is made up of a lattice work or grid of overlying transverse segments 20 and 22 shown here unconnected. These overlying segments in one embodiment are composed of molded or performed wire pairs 24 and 26 that are separated at an aperture 30. Aperture 30 in one segment 22 is adapted to overlie an aperture 30′ in an underlying crossed segment, here illustrated at 20, with a support plate 32 located within the aperture.

The subject array support panel is fabricated as a low RCS grid or lattice structure in which the segments may be located orthogonal one to the other and are cross linked at a junction aperture.

Note that the overlying apertures form cross linked segments and create a relief region for the periodic placement of the support plates. Here the support plate is illustrated with a central aperture or hole 34 adapted to accommodate a screw or bolt therethrough.

The array support panel lattice may be configured with the aforementioned apertures spaced apart at distances commensurate with the operating characteristics of the antenna to be mounted thereon, with the support plates securing the antenna elements for the formation of the antenna array.

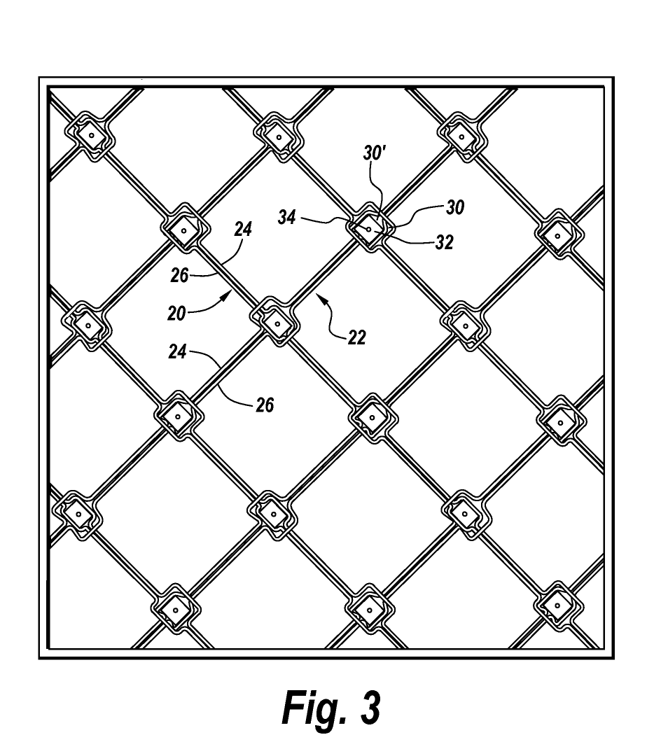

The completed array support panel lattice or grid is shown in FIG. 3 in which apertures 30 and 30′ are shown to include support plate 32 into hole 34 which is formed.

The overlying lattice work structure composed in one embodiment of orthogonal segments may be formed by welding the overlying structures together or in some other way bonding or connecting the overlying structures in a cross linking manner which may also involve interlocking features of the overlying segments.

While the subject array support panel is shown in one embodiment to incorporate mirror image wire pairs, the support structure may be made of plastic and spot welded to create the lattice type support structure, it being understood that in this particular embodiment there is no ground plane provided by the support structure.

It is noted that the support plates of FIGS. 2 and 3 may be spaced according to the frequency performance requirements defined for the antenna array being supported. It is also noted that the metallic elements of the support panel may be placed behind the active area of the antenna elements, with the area between the wire pairs that form the array grid left open to the antenna environment thus reducing the weight of the antenna array assembly while at the same time creating a support panel with little or no extra reflective surfaces. It is noted that it is the reduced reflectivity of the support panel that provides for the low radar cross section described above.

While the array support panel being of an open work lattice or grid may be used to support the printed circuit card antenna array elements shown in FIG. 1, it will be appreciated that the support plates may be utilized to support for instance vertically-upstanding antenna elements. Thus the subject array support panel is not limited to the mounting of printed circuit card antenna array elements.

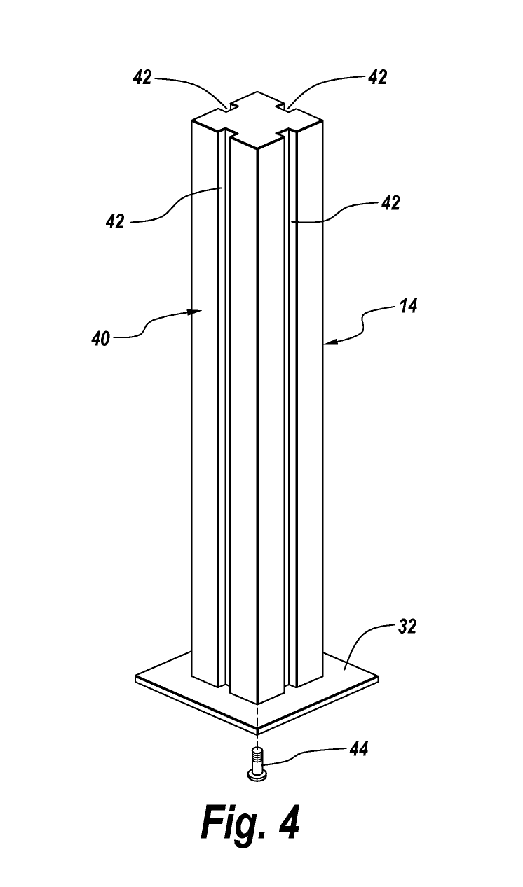

More particularly and referring to FIG. 4, columns 14 of FIG. 1 may include a square cross-section member 40 having longitudinally running slots 42 on all four sides of the member.

It will be appreciated that this column is anchored to support plate 32 with a screw or bolt 36 that runs up through hole 34 in support plate 32.

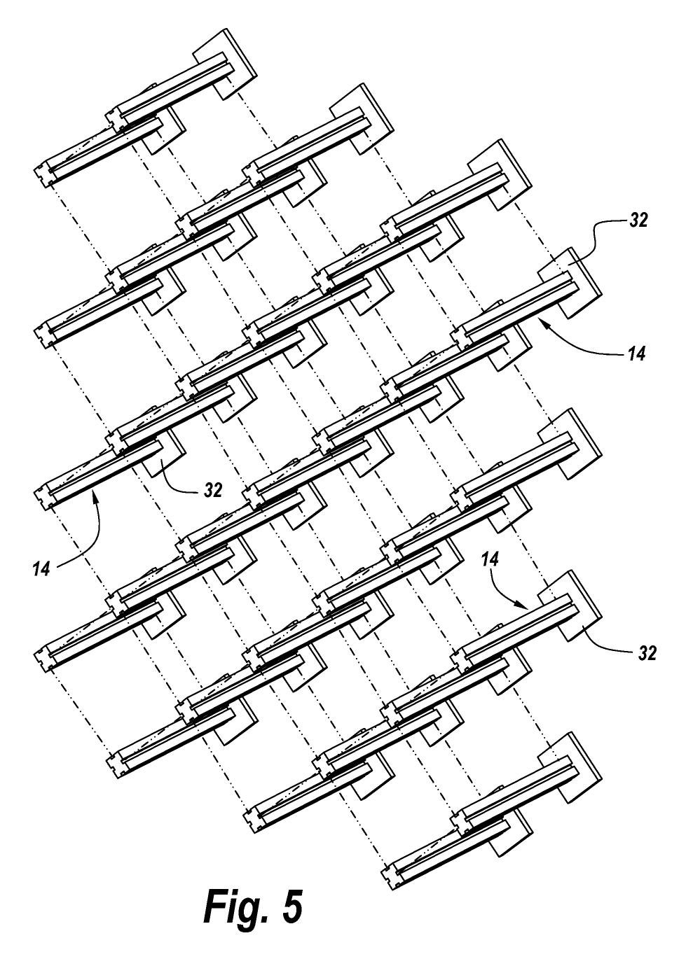

The construction of the printed circuit card antenna array element structure is shown in FIG. 5 in which numbers of support columns 14 are mounted on associated support plates 32, with the array support panel grid or lattice locating the columns in any one of a number of desired patterns to house the supported printed circuit cards. The arrangement of FIG. 5 shows an arrangement that would support the diamond shaped array of FIG. 1, but is shown for illustrative purposes only.

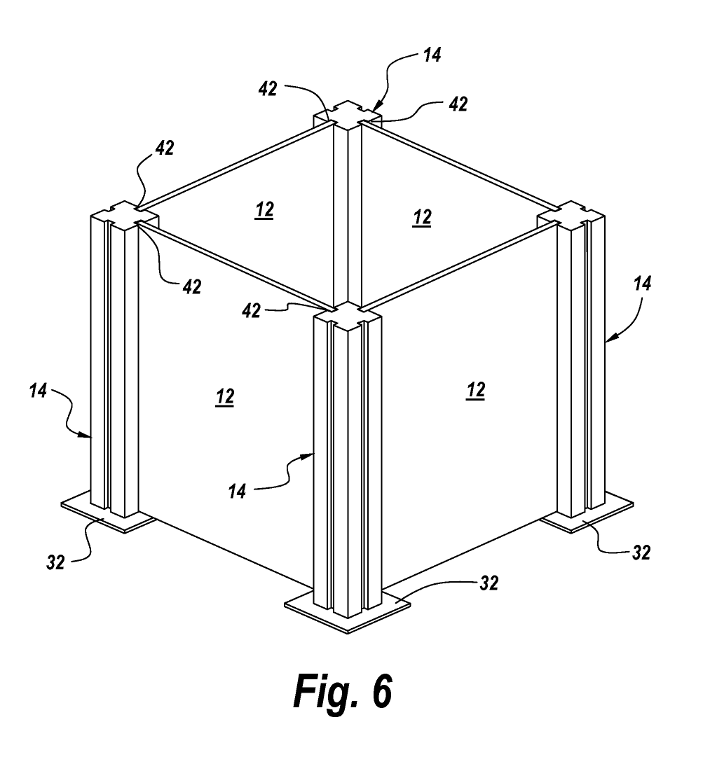

Referring to FIG. 6, what is shown are opposed columns 14 housing a printed circuit card therebetween. Here each of the columns are secured, screwed or bolted to the associated support plate 32. This provides a secure low radar cross section mounting system, with the crossovers of the lattice defining a predetermined pattern related to the operational frequency of the array.

While the present invention has been described in connection with a preferred embodiment, it is to be understood that other similar embodiments may be used or modifications and additions may be made to the described embodiment for performing the same function of the present invention without deviating therefrom. Therefore, the present invention should not be limited to any single embodiment.

What is claimed is:

1. In an antenna support panel for rigidly supporting an antenna array, wherein the improvement comprises:
a plurality of support segments; and
a plurality of junctions positioned along each support segment, wherein the support segments are configured to connect to each other at the junctions.

2. The antenna support panel of claim 1, wherein the support segments are configured to connect orthogonally at the junctions.

3. The antenna support panel of claim 1, further includes a plurality of support plates, a support plate positioned at each junction and configured to support and attach to antenna array elements.

4. The antenna support panel of claim 1, wherein the junctions includes mirror image openings in associated wire segments.

5. The antenna support panel of claim 1, wherein the junctions are positioned along the support segments according to the frequency requirements of the antenna array to be supported.

6. A method of supporting an antenna array so as to minimize the radar cross section of the array, comprising the steps of:
providing an open work lattice having support members crossing at junctions and,
mounting an element of the antenna array to the lattice structure at a junction, the open work lattice providing a minimal radar reflectivity mounting structure for the antenna array.

7. The method of claim 6, wherein the open lattice includes metal support members.

8. The method of claim 7, wherein said metal support members include wire members.

9. The method of claim 8, wherein side-by-side pairs of wire members are utilized for lattice segments.

10. The method of claim 6, wherein the lattice includes non-metallic support members.

11. The method of claim 10, wherein the non-metallic support members include plastic support members.

12. The method of claim 6, wherein the antenna array elements include printed circuit cards and wherein opposed edges of the printed circuit cards are anchored to the open work lattice at opposed junctions.

13. The method of claim 12, and further including providing upstanding notched stanchions at the junctions, with the notches adapted to receive edges of the print circuit cards.

14. The method of claim 6, and further including the step of providing support plates at the junctions.

15. The method of claim 6, wherein the junctions are positioned along a support member according to the frequency requirements of the antenna array.

16. The method of claim 6, wherein the support members of the lattice are configured to connect orthogonally at the junctions.
